(19) United States
(12) Patent Application Publication
(10) Pub. No.: US 2003/0068915 A1
(43) Pub. Date: Apr. 10, 2003

(54) Connector insert

(76) Inventor: Robert A. Roush, Norwich, CT (US)

Correspondence Address: Office Of Counsel, Naval Undersea Warfare Center Division, Bldg 112T, 1176 Howell Street, Newport, RI, 02841-1708, US

(21) Appl. No.: 09/977,908

(22) Filed: Oct. 10, 2001

(51) Int. Cl. H01R 13/52

(52) U.S. Cl. 439/271

(57) ABSTRACT

An improved electrical connector having an electrical connector housing and at least one face seal, wherein the improved electrical connector is a single molded connector housing. The electrical connector housing includes a plurality of passageways extending from a first end to a second end. A face seal includes a plurality of openings corresponding to the plurality of passageways within the electrical connector housing, each passageway having a semi-o-ring on at least one side of the face seal. In a preferred embodiment, the improved electrical connector is made form an o-ring type material such as, but not limited to, neoprene or Buna-N rubber. The improved electrical connector does not need additional seals to create a waterproof seal, and therefore does not suffer from increased tolerance stack-up. Furthermore, when constructed from an o-ring type material, the improved electrical connector does not cold flow around a receptacle's pins.

### STATEMENT OF GOVERNMENT INTEREST

The invention described herein may be manufactured and used by or for the Government of the United States of America for governmental purposes without the payment of any royalties thereon or therefore.

### CROSS REFERENCE TO OTHER PATENT APPLICATIONS

Not applicable.

### BACKGROUND OF THE INVENTION

(1) Field of the Invention

The present invention relates generally to the field of electrical connectors and more particularly, to an improved electrical connector having an integrated face seal which is especially useful in wet environments.

(2) Description of the Prior Art

Typically, electrical connectors are constructed from a plurality of parts that are separately fabricated and then assembled together into complete connectors. If the connector is designed for outside use or use in harsh environments, it is especially important that the connector be effectively sealed to prevent moisture, dust, or other contaminants from reaching the interior of the connector where they can cause corrosion or otherwise prevent proper operation of the connector. The need for an effective seal preventing moisture is especially great when the vehicle is in water, such as a ship or submersible vehicle.

Most environmental connectors are relatively complex in design so as to reliably seal the connection. Many environmental connectors utilize a RIM (reaction injected molded) face seal, generally made from neoprene. A common problem with these connectors results from the need to use separate seals in conjunction with the connectors. The additional seals result in increased tolerance stack-up. Also, existing seals tend to degrade over time. This results from the seals, generally made from polyurethane, cold-flowing around the receptacle's pins over time.

Another problem associated with complex electrical connectors results from the handling and assembling of the individual components. Because the individual parts are often manufactured separately, there is an increased likelihood that certain parts will not fit together properly. This results in imperfectly-made connectors and in an excessive number of rejects, thus increasing both manufacturing and labor costs as well as installation time.

Accordingly, what is needed is an electrical connector which effectively isolates a receptacle's pins even in a wet environment. The connector should not need additional seals which increase the tolerance stack up. The connector should be made of a material which will not cold-flow over time. Lastly, the connector should be easy to manufacture and install.

### SUMMARY OF THE INVENTION

In accordance with the present invention, an electrical connector for creating a connection with a plurality of receptacle pins located on a male receptacle is disclosed. The electrical connector includes a first end and a second opposed end, a plurality of passageways extending through the electrical connector from the first end to the second end, and at least one integral face seal. The integral face seal includes a plurality of openings having a first end and a second end corresponding to the plurality of passageways and a plurality of integral semi-o-rings located on the first end of the plurality of openings. The plurality of integral semi-o-rings are adapted to frictionally engage the plurality of receptacle pins thereby isolating the plurality of receptacle pins from one another and creating a water-proof seal. The electrical connector is molded contiguously.

In another embodiment, the electrical connector is molded from an o-ring material which is resistant to cold-flow. In a preferred embodiment, the o-ring material is neoprene or Buna-N rubber. Furthermore, the improved electrical connector is preferably constructed using reaction injection molding techniques.

### BRIEF DESCRIPTION OF THE DRAWINGS

These and other features and advantages of the present invention will be better understood in view of the following description of the invention taken together with the drawings wherein:

FIG. 1 is partial cross-sectional view of an electrical connector according to the prior art; and

FIG. 2 is a partial cross-sectional view of one embodiment of an electrical connector according to the present invention.

### DESCRIPTION OF THE PREFERRED EMBODIMENT

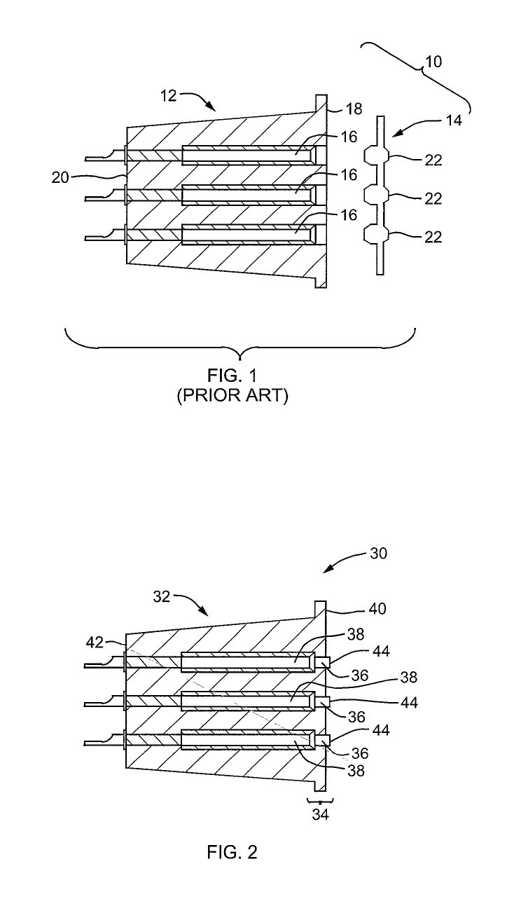

FIG. 1 illustrates the existing connector design 10 currently used in by the U.S. Navy and others. The connector design 10 utilizes an electrical connector housing 12 and a separate face seal 14. The electrical connector housing 12 has a plurality of passageways 16 extending from a first end 18 to a second end 20.

The face seal 14 is a separate component from the electrical connector housing 12. Both the electrical connector housing 12 and the face seal 14 are constructed from epoxy, generally polyurethane. The face seal 14 includes a plurality of openings 22 corresponding to the plurality of passageways 16 in the electrical connector housing 12.

In practice, the face seal 14 is placed between the electrical connector housing 12 and a corresponding electrical receptacle (not shown) having receptacle pins. Upon passing through the openings 22 of the face seal 14 to the plurality of passageways 16 in the electrical connector housing 12, the plurality of openings 22 on the face seal 14 frictionally engage the pins on the electrical receptacle creating a seal.

The prior art connection 10 described above results in increased tolerance stack-up since the face seal 14 is placed between the electrical housing 12 and the electrical receptacle. By adding the RIM, one will add to an existing stack-up (controlled by MILSPEC) which is unsatisfactory. It will interfer with sealing capabilities of the design. Also, since the electrical connector housing 12 is made of polyurethane and the face seal 14 is made of neoprene, the resulting seal degrades over time because the polyurethane cold-flows around the electrical receptacle's face. This allows water into the connector which can result in the connection short-circuiting or performing poorly.

The improved electrical connector 30 as shown in FIG. 2, is according to the present invention. It combines the electrical connector housing 32 and the face seal 34 into one contiguous piece. In a preferred embodiment, the electrical connector 30 is made from an o-ring type material which is resistant to cold-flow. The properties of the o-ring type material are listed in MIL-SPEC (military specifications). In one embodiment, the o-ring material is 60 Shore A Durometer Buna-N rubber. In another embodiment, the o-ring material is neoprene.

The electrical connector housing 32 includes a plurality of passageways 38 extending from a first end 40 to a second end 42. The face seal 34 includes a plurality of openings 36 corresponding to the plurality of passageways 38 within the electrical connector housing 32. In a preferred embodiment, each opening 44 on the face seal 34 also includes a molded-in o-ring 44 on at least the first end 40. The improved electrical connector 30 may also include additional face seals such as 14 of FIG. 1 having multiple o-rings 44 on multiple ends.

In practice, the improved electrical connector 30 mates with a receptacle (not shown) in the same manner as described above, except that a separate face seal 14, FIG. 1, is not needed. The improved electrical connector 30 creates a waterproof seal and isolates the pins of an electrical receptacle from one another, even in wet environments, without the need of a separate face seal. Because of the material used, the openings 22, FIG. 1, in the prior art face seal 14 tends to cold-flow away from the pins on an electrical receptacle when connected, thus degrading the quality and weatherproofness of the seal, ultimately resulting in poor performance. Cold-flow or creep is the tendency of a material to very slowly flow away from a high stress area. When constructed out of an o-ring type material, the improved electrical connector 30 will not cold-flow or creep. Furthermore, the improved electrical connector 30 does not suffer from tolerance stack-up since the face seal 34 is an integral part of the electrical connector housing 32.

In a preferred embodiment, the improved electrical connector 30 is constructed using reaction injection molding techniques. However, other known methods of forming rubber components may be used which are within the realm of a person of ordinary skill in the art.

In light of the above, it is therefore understood that within the scope of the appended claims, the invention may be practiced otherwise than as specifically described.

What is claimed is:

1. An improved electrical connector for creating a connection with a plurality of receptacle pins located on a male receptacle, said improved electrical connector comprising
a molded connector housing including a first end and a second opposed end;
a plurality of passageways extending through said molded connector housing from said first end to said second end; and
at least one face seal integrally molded with said connector housing and having:
a plurality of openings each having a first end and a second end, said plurality of openings corresponding to said plurality of passageways; and
a plurality of semi-o-rings integrally molded with said connector housing and located on at least said first end of said plurality of openings, said plurality of integral semi-o-rings adapted to frictionally engage with said plurality of receptacle pins when connected with said plurality of receptacle pins located on said male receptacle thereby isolating said plurality of receptacle pins from one another and creating a waterproof seal, wherein said improved electrical connector is molded contiguously from an o-ring material which is resistant to cold-flow.

2. The improved electrical connector as claimed in claim 1 wherein said o-ring material is selected from the group consisting of neoprene and Buna-N-rubber.

3. The improved electrical connector as claimed in claim 1 wherein said electrical connector is manufactured using reaction injection molding techniques.

4. An improved electrical connector for creating a connection with a plurality of receptacle pins located on a male receptacle, said improved electrical connector comprising:
a molded connector housing including a first end and a second opposed end;
a plurality of passageways extending through said molded connector housing from said first end to said second end; and
at least one face seal integrally molded with said connector housing and having: a plurality of openings each having a first and a second end, said plurality of openings corresponding to said plurality of passageways; and a plurality of molded-in o-rings integrally molded with said connector housing and located on at least said first end of said plurality of openings, said plurality of integral molded-in o-rings adapted to frictionally engage with said plurality of receptacle pins thereby isolating said plurality of receptacle pins from one another and creating a water-proof seal, wherein said improved electrical connector is molded contiguously from neoprene.

5. The improved electrical connector as claimed in claim 4 wherein said electrical connector is manufactured using reaction injection molding techniques.

6. An improved electrical connector for creating a connection with a plurality of receptacle pins located on a male receptacle, said improved electrical connector comprising:
a molded connector housing including a first and a second opposed end;
a plurality of passageways extending through said molded connector housing from said first end to said second end; and
at least one face seal integrally molded with said connector housing and having:
a plurality of openings having a first end and a second end, said plurality of openings corresponding to said plurality of passageways; and
a plurality of molded-in o-rings integrally molded with said connector housing and located on at least said first end of said plurality of openings, said plurality of integral molded-in o-rings adapted to frictionally engage said plurality of receptacle pins thereby isolating said plurality of receptacle pins from one another and creating a water-proof seal, wherein said improved electrical connector is molded contiguously from Buna-N rubber.

7. The improved electrical connector as claimed in claim 6 wherein said electrical connector is manufactured using reaction injection molding techniques.

8. An improved electrical connector for creating a connection with a plurality of receptacle pins located on a male receptacle, said improved electrical connector comprising:
a molded connector housing including a first and a second opposed end;
a plurality of passageways extending through said molded connector housing from said first end to said second end; and
at least one face seal integrally molded with said connector housing and having:
a plurality of openings having a first end and a second end, said plurality of openings corresponding to said plurality of passageways; and
a plurality of molded-in o-rings integrally molded with said connector housing and located on at least said first end of said plurality of openings, said plurality of integral molded-in o-rings adapted to frictionally engage said plurality of receptacle pins thereby isolating said plurality of receptacle pins from one another and creating a water-proof seal, wherein said improved electrical connector is molded contiguously using reaction injection molding techniques.

9. The improved electrical connector as claimed in claim 8 wherein said electrical connector is molded from an o-ring material that is resistant to cold-flow.

10. The improved electrical connector as claimed in claim 9 wherein said o-ring material is neoprene.

11. The improved electrical connector as claimed in claim 9 wherein said o-ring material is Buna-N rubber.
